(19) United States
(12) Patent Application Publication
(10) Pub. No.: US 2022/0311254 A1
(43) Pub. Date: Sep. 29, 2022

(54) CHARGING DEVICE INDICATING BATTERY PERCENTAGE

(71) Applicant: Cheng-Chun CHANG, Taipei City (TW)

(72) Inventor: Cheng-Chun CHANG, Taipei City (TW)

(21) Appl. No.: 17/539,857

(22) Filed: Dec. 1, 2021

(30) Foreign Application Priority Data
Mar. 23, 2021 (CN) 202110310793.7

(51) Int. Cl. H02J 7/00; H01R 24/60; H01R 13/66

(52) U.S. Cl. CPC H02J 7/0048; H02J 7/00034; H01R 24/60; H01R 13/6675; H02J 7/007182

(57) ABSTRACT

A charging device indicating battery percentage, including a power source connector for connecting with a power supply terminal, a charging connector for connecting with a handheld device, a cable connected between the power source connector and the charging connector, a control unit and a display unit, where the control unit is programmed to read a battery percentage of the handheld device from a memory of the handheld device through a signal path of the cable, and drive the display unit to display the battery percentage.

### BACKGROUND OF THE INVENTION

### Field of the Invention

The invention relates to a charging device, in particular to a charging device that can accurately display the battery percentage of a handheld device.

### Description of the Related Art

With the advancement of technology, electronic products are becoming lighter, thinner, shorter and smaller. General handheld electronic products, such as tablets, laptops, smart phones, audio-video players and other daily life indispensable personal electronic products, are equipped with chargers and charging/data transmission cables for battery charging and data transmission. Among those handheld electronic products, the smart phones especially need to be charged frequently because most users swipe them almost all the time.

To enable a user to recognize whether an electronic product is in charging, existing chargers often detect a charging current to indicate a charging state (fast, slow, and full) of the electronic product. However, the existing chargers can provide users only a current charging state, but not a battery percentage of the electronic product.

To solve the above problem, a Chinese patent application CN201320246856 uses a current detection loop to detect a charging current to estimate a battery percentage of a mobile phone, and then sends the information of the battery percentage to a display unit to display the battery percentage. However, as different mobile phones have different battery capacities, the Chinese patent application is prone to errors in estimating the battery percentage of a mobile phone. Besides, general battery percentage estimation formulas are not only complicated, which requires a high-performance CPU (central processing unit), but also easily affected by calculation errors.

To solve the above-mentioned problems, a novel charging device is needed in the art.

### SUMMARY OF THE INVENTION

The main objective of the present invention is to provide a charging device indicating battery percentage, which can directly obtain an accurate current battery percentage of a handheld device from a memory of the handheld device and display the current battery percentage on a display screen without the need of calculating an SOC (state of charge) of the handheld device, and thereby enable a user to instantly check the battery percentage of the handheld device from the display screen.

To achieve the above objective, a charging device indicating battery percentage is proposed, which includes a power source connector for connecting with a power supply terminal, a charging connector for connecting with a handheld device, a cable connected between the power source connector and the charging connector, a control unit and a display unit, where the control unit is programmed to read a battery percentage of the handheld device from a memory of the handheld device through a signal path of the cable, and drive the display unit to display the battery percentage.

In contrast to prior art charging devices using a detection-and-calculation circuit to detect a charging current and derive a battery percentage according to an integration of the charging current, the present invention uses the control unit to read a content at a preset address of the memory according to an interface protocol of the charging connector to directly get a real-time and accurate battery percentage, and display the battery percentage on the display unit to enable a user to get informed of the battery percentage of the handheld device effortlessly. In addition, when charging a handheld device, what users most often check is the battery percentage, therefore, it is desirable to directly show the battery percentage on the display screen for users to view.

In one embodiment, the signal path includes a pair of data lines connected between the charging connector and the power source connector, the control unit is coupled with the pair of data lines and is programmed to perform a status detection procedure to detect a communication status of the power source connector, thereby determining whether to switch on or off a data communication between the power source connector and the charging connector.

In one embodiment, the status detection procedure includes: the control unit detects whether the power source connector is receiving or transmitting data, if so, the control unit suspends reading of the battery percentage, if not, the control unit reads the battery percentage from the charging connector.

In one embodiment, the cable has a switch circuit embedded in a charging path, and the control unit drives the switch circuit to disconnect the charging path when the battery percentage is equal to or greater than a first preset value.

In one embodiment, the control unit drives the switch circuit to disconnect the charging path when the battery percentage is less than or equal to a second preset value, the first preset value being greater than the second preset value.

For possible embodiments, the control unit and the display unit can be arranged on the power source connector or the charging connector.

In one embodiment, the cable has two power lines for implementing the charging path, and at least two data lines for implementing the signal path.

In one embodiment, the control unit and the display unit are arranged on the cable.

For possible embodiments, the charging connector can be an expansion connector, a standard USB connector, a mini USB connector, a micro USB connector, a Lightning USB connector, a Type-C USB connector, or a magnetic connector; and the power source connector can be a power adaptor connector, a standard USB connector, a mini USB connector, a micro USB connector, a Lightning USB connector, a Type-C USB connector or a magnetic connector.

In one embodiment, the charging device indicating battery percentage further includes a detection circuit for detecting a charging current of the charging path to generate an auxiliary signal, and the control unit switches on or off the switch circuit according to the auxiliary signal.

To make it easier for our examiner to understand the objective of the invention, its structure, innovative features, and performance, we use preferred embodiments together with the accompanying drawings for the detailed description of the invention.

### BRIEF DESCRIPTION OF THE DRAWINGS

FIG. 1 illustrates a structure diagram of the charging device of the present invention.

FIG. 2 illustrates a circuit diagram of the charging device of the present invention.

### DETAILED DESCRIPTION OF THE PREFERRED EMBODIMENTS

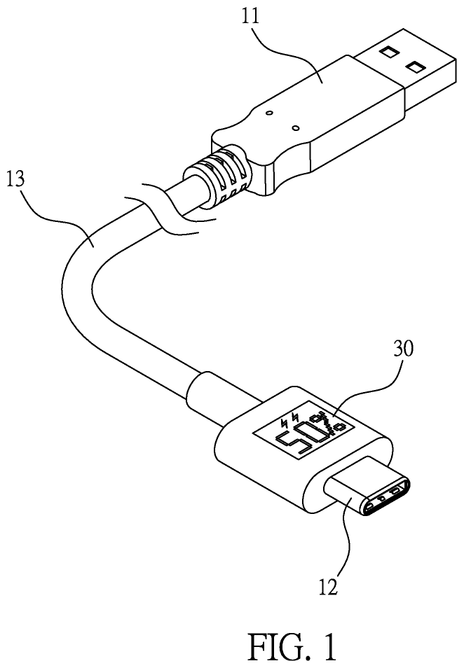

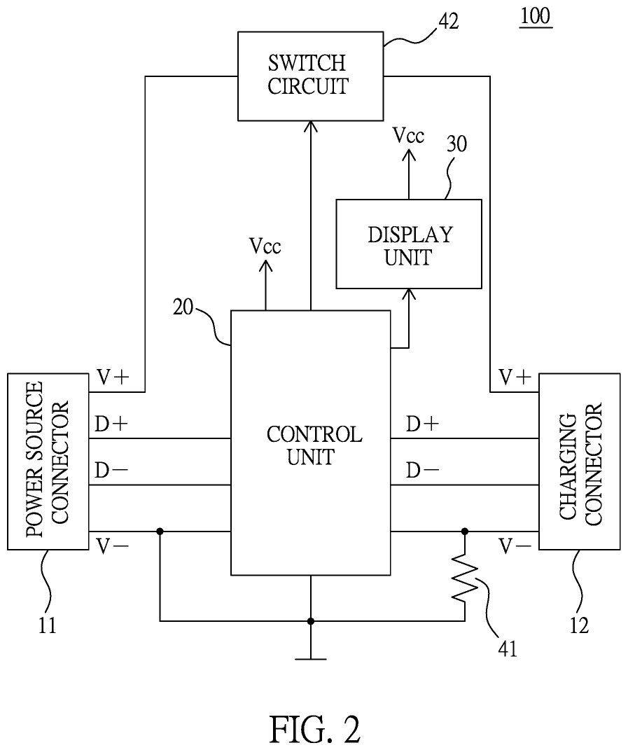

Please refer to FIGS. 1 and 2, the present invention discloses a charging device 100 indicating battery percentage of a charged device, which includes a power source connector 11 to be connected to a power supply terminal, a charging connector 12 to be connected to a handheld device, a cable 13 connected between the power source connector 11 and the charging connector 12, signal lines D+ and D− connected with the charging connector 12, a control unit 20 and a display unit 30. The control unit 20 derives a battery percentage from a preset address of a memory of the handheld device through the signal lines D+, D−, and drives the display unit 30 to display the battery percentage. When the charging device 100 is used in charging the handheld device, the power source connector 11 is connected with the power supply terminal, the charging connector 12 is connected with a connection interface of the handheld device to be charged, and the display unit 30 displays the battery percentage of the handheld device.

The handheld device can be an electronic device such as a mobile phone or a tablet computer that can detect an SOC (state of charge) of a battery therein and store the data of battery percentage according to the SOC. The power supply terminal can be an external power supply, a charging device, or an electronic device, such as a notebook computer, a computer, and so on.

The control unit 20 obtains the data of battery percentage of the handheld device and drives the display unit 30 to display the battery percentage. The charging connector 12 has a communication protocol with the handheld device, and the control unit 20 directly accesses the memory using the communication protocol to obtain the data of battery percentage.

The display unit 30 has a display screen, which can be an LED module or an LCD display screen, and so on. In this embodiment, the control unit 20 and the display unit 30 are arranged on the charging connector 12. However, the control unit 20 and the display unit 30 may also be provided on the power source connector 11.

Please refer to FIG. 1 and FIG. 2, the two ends of the cable 13 are respectively connected to the power source connector 11 and the charging connector 12, the cable 13 is provided with power lines V+, V− and signal lines D+, D−, and the power lines V+, V− are connected between the power source connector 11 and the charging connector 12 for power transmission.

In addition, the control unit 20 and the display unit 30 may be alternatively provided on the cable 13.

In addition, the charging connector 12 may be an expansion connector, or a standard, mini, micro, Lightning, or Type-C USB connector, or a magnetic connector. The power source connector 11 can be a connection interface for connecting a power adapter, or a USB connector of standard, mini, micro, or Type-C specification, or a magnetic connector.

Please refer to FIG. 2, the signal lines D+ and D− are connected between the charging connector 12 and the power source connector 11 to form a signal path. The control unit 20 is coupled with the signal path to detect the state of the power source connector 11 to switch on or off the signal path. That is, the control unit 20 of the present invention can use the signal lines D+ and D− to obtain the data of the battery percentage without adding new signal lines and without affecting the data transmission of the traditional signal lines D+ and D−.

Specifically, the control unit 20 detects whether the power source connector 11 is sending or receiving data, if so, it suspends obtaining the data of the battery percentage, and if not, it uses the signal path to obtain the data of the battery percentage.

In addition, a first interface of the control unit 20 is connected to the charging connector 12 through one pair of signal lines D+ and D−, and the second interface of the control unit 20 is connected to the power source connector 11 through another pair of signal lines D+ and D− to communicate with the charging connector 12 and the power source connector 11. When the control unit 20 detects an active data signal from the power source connector 11, it drives the first interface and the second interface to conduct, so that the signal path is turned on, and suspends obtaining the data of the battery percentage from the handheld device through the charging connector 12. When the control unit 20 does not detect an active data signal from the power source connector 11, it drives the first interface and the second interface to disconnect, obtains the data of the battery percentage from the handheld device through the charging connector 12, and drives the display unit 30 to display the battery percentage. In addition, in an alternative embodiment, the pair of data lines D+ and D− between the second interface of the control unit 20 and the power source connector 11 can be eliminated, and in this case, the path between the power source connector 11 and the charging connector 12 will allow only a charging process but not a data transmission.

In addition, the control unit 20 may further include a detection circuit 41 and a switch circuit 42. The detection circuit 41 is used to detect a charging current of a charging path to generate an auxiliary signal. The switch circuit 42 is embedded in the charging path to switch on or off the charging path, the control unit 20 receives the auxiliary signal and switches on or off the switch circuit 42 according to the auxiliary signal. In this embodiment, the detection circuit 41 may be a current sensing circuit for sensing the charging current of the charging path. The control unit 20 compares the charging current with a threshold and drives the switch circuit 42 to switch off the charging path when the charging current exceeds the threshold, thereby providing an overcurrent protection.

In addition, the control unit 20 also drives the switch circuit 42 to switch off the charging path when the battery percentage reaches or exceeds a first preset value, thereby providing a full-charge disconnection; when the battery percentage is lower than a second preset value, the switch circuit 42 is turned on to start a charging process, where the first preset value is greater than the second preset value, the first preset value may be 100% or 99%, the second preset value may be 95% or 98%, and the specific values can be adjusted according to actual needs and are not limited to the above values.

With the designs disclosed above, the present invention possesses the following advantages:

1. The charging device of the present invention can directly obtain the data of an accurate current battery percentage of a handheld device from a memory of the handheld device and display the current battery percentage on a display screen without the need of calculating an SOC (state of charge) of the handheld device, and thereby enable a user to instantly check the battery percentage of the handheld device from the display screen.

2. The charging device of the present invention can avoid ending a charging process for a handheld device too soon before the handheld device is fully charged; in contrast, prior art charging devices generally set a lower threshold to guarantee a handheld device is fully charged due to a fact that their judgement of a fully charged status of the handheld device is inaccurate, and this can cause damage to a battery of the handheld device.

3. The charging device of the present invention can still detect a current battery percentage of a handheld device even after a charging process of the handheld device is ended.

While the invention has been described by way of example and in terms of preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

In summation of the above description, the present invention herein enhances the performance over the conventional structure and further complies with the patent application requirements and is submitted to the Patent and Trademark Office for review and granting of the commensurate patent rights.

What is claimed is:

1. A charging device indicating battery percentage, which includes a power source connector for connecting with a power supply terminal, a charging connector for connecting with a handheld device, a cable connected between the power source connector and the charging connector, a control unit and a display unit, characterized in that:
the control unit is programmed to read a battery percentage of the handheld device from a memory of the handheld device through a signal path of the cable, and drive the display unit to display the battery percentage.

2. The charging device indicating battery percentage according to claim 1, wherein the signal path includes a pair of data lines connected between the charging connector and the power source connector, the control unit is coupled with the pair of data lines and is programmed to perform a status detection procedure to detect a communication status of the power source connector, thereby determining whether to switch on or off a data communication between the power source connector and the charging connector.

3. The charging device indicating battery percentage according to claim 2, wherein the status detection procedure includes: the control unit detects whether the power source connector is receiving or transmitting data, if so, the control unit suspends reading of the battery percentage, and if not, the control unit reads the battery percentage from the charging connector.

4. The charging device indicating battery percentage according to claim 1, wherein the cable has a switch circuit embedded in a charging path, and the control unit drives the switch circuit to disconnect the charging path when the battery percentage is equal to or greater than a first preset value.

5. The charging device indicating battery percentage according to claim 4, wherein the control unit drives the switch circuit to disconnect the charging path when the battery percentage is less than or equal to a second preset value, the first preset value being greater than the second preset value.

6. The charging device indicating battery percentage according to claim 1, wherein the control unit and the display unit are arranged on the power source connector or the charging connector.

7. The charging device indicating battery percentage according to claim 1, wherein the cable has two power lines for implementing the charging path, and at least two data lines for implementing the signal path.

8. The charging device indicating battery percentage according to claim 7, wherein the control unit and the display unit are arranged on the cable.

9. The charging device indicating battery percentage according to claim 1, wherein the charging connector is selected from a group consisting of an expansion connector, a standard USB connector, a mini USB connector, a micro USB connector, a Lightning USB connector, a Type-C USB connector, and a magnetic connector; and the power source connector is selected from a group consisting of a power adaptor connector, a standard USB connector, a mini USB connector, a micro USB connector, a Lightning USB connector, a Type-C USB connector and a magnetic connector.

10. The charging device indicating battery percentage according to claim 1, further comprising a detection circuit and a switch circuit, the detection circuit being used for detecting a charging current of the charging path to generate an auxiliary signal, and the control unit switches on or off the switch circuit according to the auxiliary signal.
